(19) United States
(12) Patent Application Publication
(10) Pub. No.: US 2025/0006177 A1
(43) Pub. Date: Jan. 2, 2025

(54) METHOD FOR PROVIDING VOICE SYNTHESIS SERVICE AND SYSTEM THEREFOR

(71) Applicant: LG ELECTRONICS INC., Seoul (KR)

(72) Inventors: Siyoung YANG, Seoul (KR); Sangki KIM, Seoul (KR); Sungmin HAN, Seoul (KR)

(73) Assignee: LG ELECTRONICS INC., Seoul (KR)

(21) Appl. No.: 18/708,348

(22) PCT Filed: Oct. 20, 2022
(86) PCT No.: PCT/KR2022/015990

§ 371 Date: May 8, 2024

(30) Foreign Application Priority Data
Nov. 9, 2021 (KR) 10-2021-0153451

(51) Int. Cl. G10L 13/08; G10L 13/033

(52) U.S. Cl. CPC G10L 13/08; G10L 13/0335

(57) ABSTRACT

A method for providing a voice synthesis service and a system therefor are disclosed. A method of providing a voice synthesis service according to at least one of various embodiments of the present disclosure may comprise the steps of: receiving sound source data for synthesizing a voice of a speaker for a plurality of predefined first texts through a voice synthesis service platform that provides a development toolkit; performing tone conversion training on the sound source data of the speaker using a pre-generated tone conversion base model; generating a voice synthesis model for the speaker through the voice conversion training; receiving a second text; generating a voice synthesis model through voice synthesis inference on the basis of the voice synthesis model for the speaker and the second text; and generating a synthesized voice using the voice synthesis model.

### TECHNICAL FIELD

This disclosure relates to a method and system for providing a voice synthesis service based on tone or timbre conversion.

### BACKGROUND

Voice recognition technology, which originated in smartphones, has a structure that utilizes a huge amount of database to select the optimal answer to the user's question.

In contrast to this voice recognition technology, there is voice synthesis technology.

Voice synthesis technology is a technology that automatically converts input text into a voice waveform containing corresponding phonological information, and is usefully used in various voice application fields such as conventional automatic response systems (ARS) and computer games.

Representative voice synthesis technologies include corpus-based audio concatenation-based voice synthesis technology and HMM (hidden Markov model)-based parameter-based voice synthesis technology.

### Technical Object

The purpose of the present disclosure is to provide a method and system for providing a user's unique voice synthesis service based on tone conversion.

### Technical Solution

According to at least one embodiment among various embodiments, a method of providing voice synthesis service may include receiving sound source data for synthesizing a speaker's voice for a plurality of predefined first texts through a voice synthesis service platform that provides a development toolkit; learning tone conversion for the speaker's sound source data using a pre-generated tone conversion base model; generating a voice synthesis model for the speaker through learning the tone conversion; being inputted second text; generating a voice synthesis model through voice synthesis inference based on the voice synthesis model for the speaker and the second text; and generating a synthesized voice using the voice synthesis model.

According to at least one embodiment among various embodiments, an artificial intelligence-based voice synthesis service system may include an artificial intelligence device; and a computing device configure to exchanges data with the artificial intelligence device, wherein the computing device includes: a processor configured to: receive sound source data for synthesizing a speaker's voice for a plurality of predefined first texts through a voice synthesis service platform that provides a development toolkit, learn tone conversion for the speaker's sound source data using a pre-generated tone conversion base model, generate a voice synthesis model for the speaker through learning the tone conversion, when being inputted second text, generate a voice synthesis model through voice synthesis inference based on the voice synthesis model for the speaker and the second text, and generate a synthesized voice using the voice synthesis model.

Further scope of applicability of the present invention will become apparent from the detailed description that follows. However, since various changes and modifications within the scope of the present invention may be clearly understood by those skilled in the art, the detailed description and specific embodiments such as preferred embodiments of the present invention should be understood as being given only as examples.

### Effects of the Invention

According to at least one embodiment among various embodiments of the present disclosure, there is an effect of allowing a user to more easily and conveniently create his or her own unique voice synthesis model through a voice synthesis service platform based on timbre conversion.

According to at least one embodiment among various embodiments of the present disclosure, there is an effect that a unique voice synthesis model can be used on various media such as social media or personal broadcasting platforms.

According to at least one embodiment of the various embodiments of the present disclosure, a personalized voice synthesizer can be used even in virtual spaces or virtual characters such as digital humans or Metaverse.

### BRIEF DESCRIPTION OF THE DRAWINGS

FIG. 1 is a diagram for explaining a voice system according to an embodiment of the present invention.

FIG. 2 is a block diagram for explaining the configuration of an artificial intelligence device according to an embodiment of the present disclosure.

FIG. 3 is a block diagram for explaining the configuration of a voice service server according to an embodiment of the present invention.

FIG. 4 is a diagram illustrating an example of converting a voice signal into a power spectrum according to an embodiment of the present invention.

FIG. 5 is a block diagram illustrating the configuration of a processor for voice recognition and synthesis of an artificial intelligence device, according to an embodiment of the present invention.

FIG. 6 is a block diagram of a voice service system for voice synthesis according to an embodiment of the present disclosure.

FIG. 7 is a block diagram of an artificial intelligence device according to another embodiment of the present disclosure.

FIG. 8 is a diagram illustrating a method of registering a user-defined long-distance trigger word in a voice service system according to an embodiment of the present disclosure.

FIG. 9 is a flow chart illustrating a voice synthesis service process according to an embodiment of the present disclosure.

FIGS. 10A to 15D are diagrams to explain a process of using a voice synthesis service on a service platform using a development toolkit according to an embodiment of the present disclosure.

### BEST MODE

Hereinafter, embodiments are described in more detail with reference to accompanying drawings and regardless of the drawings symbols, same or similar components are assigned with the same reference numerals and thus repetitive for those are omitted. Since the suffixes “module” and “unit” for components used in the following description are given and interchanged for easiness in making the present disclosure, they do not have distinct meanings or functions. In the following description, detailed descriptions of well-known functions or constructions will be omitted because they would obscure the inventive concept in unnecessary detail. Also, the accompanying drawings are used to help easily understanding embodiments disclosed herein but the technical idea of the inventive concept is not limited thereto. It should be understood that all of variations, equivalents or substitutes contained in the concept and technical scope of the present disclosure are also included.

Although the terms including an ordinal number, such as “first” and “second”, are used to describe various components, the components are not limited to the terms. The terms are used to distinguish between one component and another component.

It will be understood that when a component is referred to as being coupled with/to” or “connected to” another component, the component may be directly coupled with/to or connected to the another component or an intervening component may be present therebetween. Meanwhile, it will be understood that when a component is referred to as being directly coupled with/to” or “connected to” another component, an intervening component may be absent therebetween.

An artificial intelligence (AI) device illustrated according to the present disclosure may include a cellular phone, a smart phone, a laptop computer, a digital broadcasting AI device, a personal digital assistants (PDA), a portable multimedia player (PMP), a navigation system, a slate personal computer (PC), a table PC, an ultrabook, a wearable device (for example, a watch-type AI device (smartwatch), a glass-type AI device (a smart glass), or a head mounted display (HMD)), but is not limited thereto.

For instance, an artificial intelligence device 10 may be applied to a stationary-type AI device such as a smart TV, a desktop computer, a digital signage, a refrigerator, a washing machine, an air conditioner, or a dish washer.

In addition, the AI device 10 may be applied even to a stationary robot or a movable robot.

In addition, the AI device 10 may perform the function of a speech agent. The speech agent may be a program for recognizing the voice of a user and for outputting a response suitable for the recognized voice of the user, in the form of a voice.

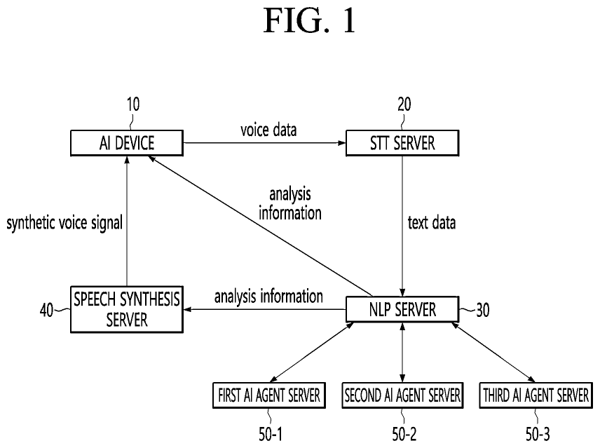

FIG. 1 is a view illustrating a speech system according to an embodiment of the present disclosure.

A typical process of recognizing and synthesizing a voice may include converting speaker voice data into text data, analyzing a speaker intention based on the converted text data, converting the text data corresponding to the analyzed intention into synthetic voice data, and outputting the converted synthetic voice data. As shown in FIG. 1, a speech recognition system 1 may be used for the process of recognizing and synthesizing a voice.

Referring to FIG. 1, the speech recognition system 1 may include the AI device 10, a Speech-To-Text (STT) server 20, a Natural Language Processing (NLP) server 30, a speech synthesis server 40, and a plurality of AI agent servers 50-1 to 50-3.

The AI device 10 may transmit, to the STT server 20, a voice signal corresponding to the voice of a speaker received through a micro-phone 122.

The STT server 20 may convert voice data received from the AI device 10 into text data.

The STT server 20 may increase the accuracy of voice-text conversion by using a language model.

A language model may refer to a model for calculating the probability of a sentence or the probability of a next word coming out when previous words are given.

For example, the language model may include probabilistic language models, such as a Unigram model, a Bigram model, or an N-gram model.

The Unigram model is a model formed on the assumption that all words are completely independently utilized, and obtained by calculating the probability of a row of words by the probability of each word.

The Bigram model is a model formed on the assumption that a word is utilized dependently on one previous word.

The N-gram model is a model formed on the assumption that a word is utilized dependently on (n−1) number of previous words.

In other words, the STT server 20 may determine whether the text data is appropriately converted from the voice data, based on the language model. Accordingly, the accuracy of the conversion to the text data may be enhanced.

The NLP server 30 may receive the text data from the STT server 20. The STT server 20 may be included in the NLP server 30.

The NLP server 30 may analyze text data intention, based on the received text data.

The NLP server 30 may transmit intention analysis information indicating a result obtained by analyzing the text data intention, to the AI device 10.

For another example, the NLP server 30 may transmit the intention analysis information to the speech synthesis server 40. The speech synthesis server 40 may generate a synthetic voice based on the intention analysis information, and may transmit the generated synthetic voice to the AI device 10.

The NLP server 30 may generate the intention analysis information by sequentially performing the steps of analyzing a morpheme, of parsing, of analyzing a speech-act, and of processing a conversation, with respect to the text data.

The step of analyzing the morpheme is to classify text data corresponding to a voice uttered by a user into morpheme units, which are the smallest units of meaning, and to determine the word class of the classified morpheme.

The step of the parsing is to divide the text data into noun phrases, verb phrases, and adjective phrases by using the result from the step of analyzing the morpheme and to determine the relationship between the divided phrases.

The subjects, the objects, and the modifiers of the voice uttered by the user may be determined through the step of the parsing.

The step of analyzing the speech-act is to analyze the intention of the voice uttered by the user using the result from the step of the parsing. Specifically, the step of analyzing the speech-act is to determine the intention of a sentence, for example, whether the user is asking a question, requesting, or expressing a simple emotion.

The step of processing the conversation is to determine whether to make an answer to the speech of the user, make a response to the speech of the user, and ask a question for additional information, by using the result from the step of analyzing the speech-act.

After the step of processing the conversation, the NLP server 30 may generate intention analysis information including at least one of an answer to an intention uttered by the user, a response to the intention uttered by the user, or an additional information inquiry for an intention uttered by the user.

The NLP server 30 may transmit a retrieving request to a retrieving server (not shown) and may receive retrieving information corresponding to the retrieving request, to retrieve information corresponding to the intention uttered by the user.

When the intention uttered by the user is present in retrieving content, the retrieving information may include information on the content to be retrieved.

The NLP server 30 may transmit retrieving information to the AI device 10, and the AI device 10 may output the retrieving information.

Meanwhile, the NLP server 30 may receive text data from the AI device 10. For example, when the AI device 10 supports a voice text conversion function, the AI device 10 may convert the voice data into text data, and transmit the converted text data to the NLP server 30.

The speech synthesis server 40 may generate a synthetic voice by combining voice data which is previously stored.

The speech synthesis server 40 may record a voice of one person selected as a model and divide the recorded voice in the unit of a syllable or a word.

The speech synthesis server 40 may store the voice divided in the unit of a syllable or a word into an internal database or an external database.

The speech synthesis server 40 may retrieve, from the database, a syllable or a word corresponding to the given text data, may synthesize the combination of the retrieved syllables or words, and may generate a synthetic voice.

The speech synthesis server 40 may store a plurality of voice language groups corresponding to each of a plurality of languages.

For example, the speech synthesis server 40 may include a first voice language group recorded in Korean and a second voice language group recorded in English.

The speech synthesis server 40 may translate text data in the first language into a text in the second language and generate a synthetic voice corresponding to the translated text in the second language, by using a second voice language group.

The speech synthesis server 40 may transmit the generated synthetic voice to the AI device 10.

The speech synthesis server 40 may receive analysis information from the NLP server 30. The analysis information may include information obtained by analyzing the intention of the voice uttered by the user.

The speech synthesis server 40 may generate a synthetic voice in which a user intention is reflected, based on the analysis information.

According to an embodiment, the STT server 20, the NLP server 30, and the speech synthesis server 40 may be implemented in the form of one server.

The functions of each of the STT server 20, the NLP server 30, and the speech synthesis server 40 described above may be performed in the AI device 10. To this end, the AI device 10 may include at least one processor.

Each of a plurality of AI agent servers 50-1 to 50-3 may transmit the retrieving information to the NLP server 30 or the AI device 10 in response to a request by the NLP server 30.

When intention analysis result of the NLP server 30 corresponds to a request (content retrieving request) for retrieving content, the NLP server 30 may transmit the content retrieving request to at least one of a plurality of AI agent servers 50-1 to 50-3, and may receive a result (the retrieving result of content) obtained by retrieving content, from the corresponding server.

The NLP server 30 may transmit the received retrieving result to the AI device 10.

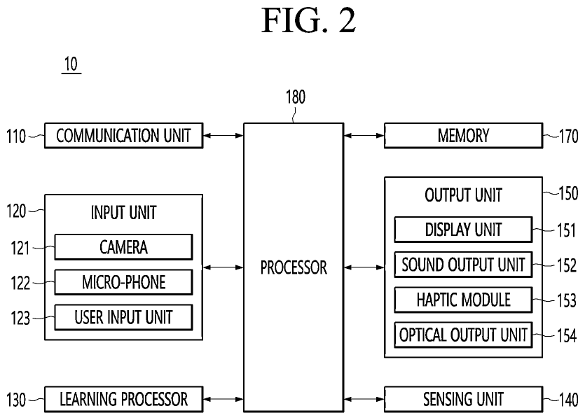

FIG. 2 is a block diagram illustrating a configuration of an AI device 10 according to an embodiment of the present disclosure.

Referring to FIG. 2, the AI device 10 may include a communication unit 110, an input unit 120, a learning processor 130, a sensing unit 140, an output unit 150, a memory 170, and a processor 180.

The communication unit 110 may transmit and receive data to and from external devices through wired and wireless communication technologies. For example, the communication unit 110 may transmit and receive sensor information, a user input, a learning model, and a control signal to and from external devices.

In this case, communication technologies used by the communication unit 110 include Global System for Mobile Communication (GSM), Code Division Multi Access (CDMA), Long Term Evolution (LTE), 5G (Generation), Wireless LAN (WLAN), Wireless-Fidelity (Wi-Fi), Bluetooth™, RFID (NFC), Infrared Data Association (IrDA), ZigBee, and Near Field Communication (NFC).

The input unit 120 may acquire various types of data.

The input unit 120 may include a camera to input a video signal, a microphone to receive an audio signal, or a user input unit to receive information from a user. In this case, when the camera or the microphone is treated as a sensor, the signal obtained from the camera or the microphone may be referred to as sensing data or sensor information.

The input unit 120 may acquire input data to be used when acquiring an output by using learning data and a learning model for training a model. The input unit 120 may acquire unprocessed input data. In this case, the processor 180 or the learning processor 130 may extract an input feature for pre-processing for the input data.

The input unit 120 may include a camera 121 to input a video signal, a micro-phone 122 to receive an audio signal, and a user input unit 123 to receive information from a user.

Voice data or image data collected by the input unit 120 may be analyzed and processed using a control command of the user.

The input unit 120, which inputs image information (or a signal), audio information (or a signal), data, or information input from a user, may include one camera or a plurality of cameras 121 to input image information, in the AI device 10.

The camera 121 may process an image frame, such as a still image or a moving picture image, which is obtained by an image sensor in a video call mode or a photographing mode. The processed image frame may be displayed on the display unit 151 or stored in the memory 170.

The micro-phone 122 processes an external sound signal as electrical voice data. The processed voice data may be variously utilized based on a function (or an application program which is executed) being performed by the AI device 10. Meanwhile, various noise cancellation algorithms may be applied to the microphone 122 to remove noise caused in a process of receiving an external sound signal.

The user input unit 123 receives information from the user. When information is input through the user input unit 123, the processor 180 may control the operation of the AI device 10 to correspond to the input information.

The user input unit 123 may include a mechanical input unit (or a mechanical key, for example, a button positioned at a front/rear surface or a side surface of the terminal 100, a dome switch, a jog wheel, or a jog switch), and a touch-type input unit. For example, the touch-type input unit may include a virtual key, a soft key, or a visual key displayed on the touch screen through software processing, or a touch key disposed in a part other than the touch screen.

The learning processor 130 may train a model formed based on an artificial neural network by using learning data. The trained artificial neural network may be referred to as a learning model. The learning model may be used to infer a result value for new input data, rather than learning data, and the inferred values may be used as a basis for the determination to perform any action.

The learning processor 130 may include a memory integrated with or implemented in the AI device 10. Alternatively, the learning processor 130 may be implemented using an external memory directly connected to the memory 170 and the AI device or a memory retained in an external device.

The sensing unit 140 may acquire at least one of internal information of the AI device 10, surrounding environment information of the AI device 10, or user information of the AI device 10, by using various sensors.

In this case, sensors included in the sensing unit 140 include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a Lidar or a radar.

The output unit 150 may generate an output related to vision, hearing, or touch.

The output unit 150 may include at least one of a display unit 151, a sound output unit 152, a haptic module 153, or an optical output unit 154.

The display unit 151 displays (or outputs) information processed by the AI device 10. For example, the display unit 151 may display execution screen information of an application program driven by the AI device 10, or a User interface (UI) and graphical User Interface (GUI) information based on the execution screen information.

As the display unit 151 forms a mutual layer structure together with a touch sensor or is integrally formed with the touch sensor, the touch screen may be implemented. The touch screen may function as the user input unit 123 providing an input interface between the AI device 10 and the user, and may provide an output interface between a terminal 100 and the user.

The sound output unit 152 may output audio data received from the communication unit 110 or stored in the memory 170 in a call signal reception mode, a call mode, a recording mode, a voice recognition mode, and a broadcast receiving mode.

The sound output unit 152 may include at least one of a receiver, a speaker, or a buzzer.

The haptic module 153 generates various tactile effects which the user may feel. A representative tactile effect generated by the haptic module 153 may be vibration.

The light outputting unit 154 outputs a signal for notifying that an event occurs, by using light from a light source of the AI device 10. Events occurring in the AI device 10 may include message reception, call signal reception, a missed call, an alarm, schedule notification, email reception, and reception of information through an application.

The memory 170 may store data for supporting various functions of the AI device 10. For example, the memory 170 may store input data, learning data, a learning model, and a learning history acquired by the input unit 120.

The processor 180 may determine at least one executable operation of the AI device 10, based on information determined or generated using a data analysis algorithm or a machine learning algorithm. In addition, the processor 180 may perform an operation determined by controlling components of the AI device 10.

The processor 180 may request, retrieve, receive, or utilize data of the learning processor 130 or data stored in the memory 170, and may control components of the AI device 10 to execute a predicted operation or an operation, which is determined as preferred, of the at least one executable operation.

When the connection of the external device is required to perform the determined operation, the processor 180 may generate a control signal for controlling the relevant external device and transmit the generated control signal to the relevant external device.

The processor 180 may acquire intention information from the user input and determine a request of the user, based on the acquired intention information.

The processor 180 may acquire intention information corresponding to the user input by using at least one of an STT engine to convert a voice input into a character string or an NLP engine to acquire intention information of a natural language.

At least one of the STT engine or the NLP engine may at least partially include an artificial neural network trained based on a machine learning algorithm. In addition, at least one of the STT engine and the NLP engine may be trained by the learning processor 130, by the learning processor 240 of the AI server 200, or by distributed processing into the learning processor 130 and the learning processor 240.

The processor 180 may collect history information including the details of an operation of the AI device 10 or a user feedback on the operation, store the collected history information in the memory 170 or the learning processor 130, or transmit the collected history information to an external device such as the AI server 200. The collected history information may be used to update the learning model.

The processor 180 may control at least some of the components of the AI device 10 to run an application program stored in the memory 170. Furthermore, the processor 180 may combine at least two of the components, which are included in the AI device 10, and operate the combined components, to run the application program.

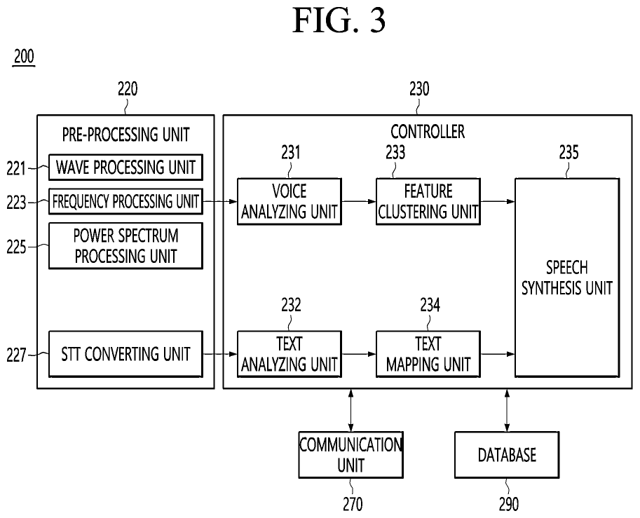

FIG. 3 is a block diagram illustrating the configuration of a voice service server according to an embodiment of the present disclosure.

The speech service server 200 may include at least one of the STT server 20, the NLP server 30, or the speech synthesis server 40 illustrated in FIG. 1. The speech service server 200 may be referred to as a server system.

Referring to FIG. 3, the speech service server 200 may include a pre-processing unit 220, a controller 230, a communication unit 270, and a database 290.

The pre-processing unit 220 may pre-process the voice received through the communication unit 270 or the voice stored in the database 290.

The pre-processing unit 220 may be implemented as a chip separate from the controller 230, or as a chip included in the controller 230.

The pre-processing unit 220 may receive a voice signal (which the user utters) and filter out a noise signal from the voice signal, before converting the received voice signal into text data.

When the pre-processing unit 220 is provided in the AI device 10, the pre-processing unit 220 may recognize a wake-up word for activating voice recognition of the AI device 10. The pre-processing unit 220 may convert the wake-up word received through the micro-phone 121 into text data. When the converted text data is text data corresponding to the wake-up word previously stored, the pre-processing unit 220 may make a determination that the wake-up word is recognized.

The pre-processing unit 220 may convert the noise-removed voice signal into a power spectrum.

The power spectrum may be a parameter indicating the type of a frequency component and the size of a frequency included in a waveform of a voice signal temporarily fluctuating.

The power spectrum shows the distribution of amplitude square values as a function of the frequency in the waveform of the voice signal.

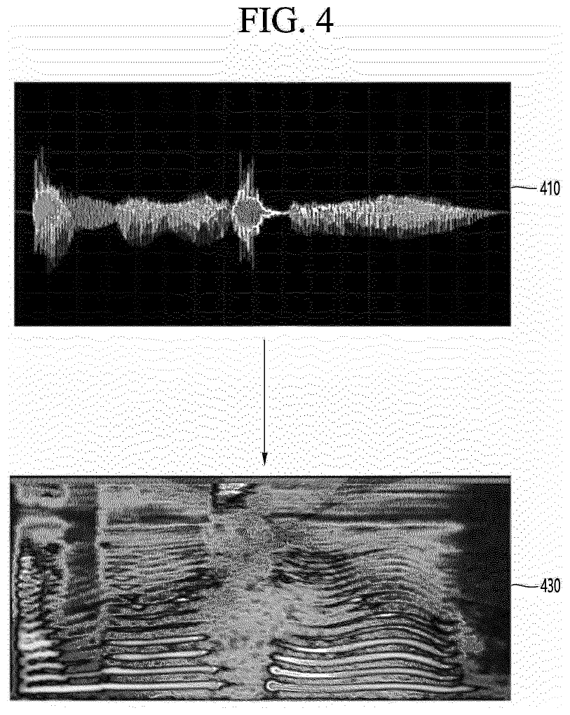

The details thereof be described with reference to FIG. 4 later.

FIG. 4 is a view illustrating that a voice signal is converted into a power spectrum according to an embodiment of the present disclosure.

Referring to FIG. 4, a voice signal 410 is illustrated. The voice signal 210 may be a signal received from an external device or previously stored in the memory 170.

An x-axis of the voice signal 410 may indicate time, and the y-axis may indicate the magnitude of the amplitude.

The power spectrum processing unit 225 may convert the voice signal 310 having an x-axis as a time axis into a power spectrum 430 having an x-axis as a frequency axis.

The power spectrum processing unit 225 may convert the voice signal 310 into the power spectrum 430 by using fast Fourier Transform (FFT).

The x-axis and the y-axis of the power spectrum 430 represent a frequency, and a square value of the amplitude.

FIG. 3 will be described again.

The functions of the pre-processing unit 220 and the controller 230 described in FIG. 3 may be performed in the NLP server 30.

The pre-processing unit 220 may include a wave processing unit 221, a frequency processing unit 223, a power spectrum processing unit 225, and a STT converting unit 227.

The wave processing unit 221 may extract a waveform from a voice.

The frequency processing unit 223 may extract a frequency band from the voice.

The power spectrum processing unit 225 may extract a power spectrum from the voice.

The power spectrum may be a parameter indicating a frequency component and the size of the frequency component included in a waveform temporarily fluctuating, when the waveform temporarily fluctuating is provided.

The STT converting unit 227 may convert a voice into a text.

The STT converting unit 227 may convert a voice made in a specific language into a text made in a relevant language.

The controller 230 may control the overall operation of the speech service server 200.

The controller 230 may include a voice analyzing unit 231, a text analyzing unit 232, a feature clustering unit 233, a text mapping unit 234, and a speech synthesis unit 235.

The voice analyzing unit 231 may extract characteristic information of a voice by using at least one of a voice waveform, a voice frequency band, or a voice power spectrum which is pre-processed by the pre-processing unit 220.

The characteristic information of the voice may include at least one of information on the gender of a speaker, a voice (or tone) of the speaker, a sound pitch, the intonation of the speaker, a speech rate of the speaker, or the emotion of the speaker.

In addition, the characteristic information of the voice may further include the tone of the speaker.

The text analyzing unit 232 may extract a main expression phrase from the text converted by the STT converting unit 227.

When detecting that the tone is changed between phrases, from the converted text, the text analyzing unit 232 may extract the phrase having the different tone as the main expression phrase.

When a frequency band is changed to a preset band or more between the phrases, the text analyzing unit 232 may determine that the tone is changed.

The text analyzing unit 232 may extract a main word from the phrase of the converted text. The main word may be a noun which exists in a phrase, but the noun is provided only for the illustrative purpose.

The feature clustering unit 233 may classify a speech type of the speaker using the characteristic information of the voice extracted by the voice analyzing unit 231.

The feature clustering unit 233 may classify the speech type of the speaker, by placing a weight to each of type items constituting the characteristic information of the voice.

The feature clustering unit 233 may classify the speech type of the speaker, using an attention technique of the deep learning model.

The text mapping unit 234 may translate the text converted in the first language into the text in the second language.

The text mapping unit 234 may map the text translated in the second language to the text in the first language.

The text mapping unit 234 may map the main expression phrase constituting the text in the first language to the phrase of the second language corresponding to the main expression phrase.

The text mapping unit 234 may map the speech type corresponding to the main expression phrase constituting the text in the first language to the phrase in the second language. This is to apply the speech type, which is classified, to the phrase in the second language.

The speech synthesis unit 235 may generate the synthetic voice by applying the speech type, which is classified in the feature clustering unit 233, and the tone of the speaker to the main expression phrase of the text translated in the second language by the text mapping unit 234.

The controller 230 may determine a speech feature of the user by using at least one of the transmitted text data or the power spectrum 330.

The speech feature of the user may include the gender of a user, the pitch of a sound of the user, the sound tone of the user, the topic uttered by the user, the speech rate of the user, and the voice volume of the user.

The controller 230 may obtain a frequency of the voice signal 310 and an amplitude corresponding to the frequency using the power spectrum 330.

The controller 230 may determine the gender of the user who utters the voice, by using the frequency band of the power spectrum 230.

For example, when the frequency band of the power spectrum 330 is within a preset first frequency band range, the controller 230 may determine the gender of the user as a male.

When the frequency band of the power spectrum 330 is within a preset second frequency band range, the controller 230 may determine the gender of the user as a female. In this case, the second frequency band range may be greater than the first frequency band range.

The controller 230 may determine the pitch of the voice, by using the frequency band of the power spectrum 330.

For example, the controller 230 may determine the pitch of a sound, based on the magnitude of the amplitude, within a specific frequency band range.

The controller 230 may determine the tone of the user by using the frequency band of the power spectrum 330. For example, the controller 230 may determine, as a main sound band of a user, a frequency band having at least a specific magnitude in an amplitude, and may determine the determined main sound band as a tone of the user.

The controller 230 may determine the speech rate of the user based on the number of syllables uttered per unit time, which are included in the converted text data.

The controller 230 may determine the uttered topic by the user through a Bag-Of-Word Model technique, with respect to the converted text data.

The Bag-Of-Word Model technique is to extract mainly used words based on the frequency of words in sentences. Specifically, the Bag-Of-Word Model technique is to extract unique words within a sentence and to express the frequency of each extracted word as a vector to determine the feature of the uttered topic.

For example, when words such as “running” and “physical strength” frequently appear in the text data, the controller 230 may classify, as exercise, the uttered topic by the user.

The controller 230 may determine the uttered topic by the user from text data using a text categorization technique which is well known. The controller 230 may extract a keyword from the text data to determine the uttered topic by the user.

The controller 230 may determine the voice volume of the user voice, based on amplitude information in the entire frequency band.

For example, the controller 230 may determine the voice volume of the user, based on an amplitude average or a weight average in each frequency band of the power spectrum.

The communication unit 270 may make wired or wireless communication with an external server.

The database 290 may store a voice in a first language, which is included in the content.

The database 290 may store a synthetic voice formed by converting the voice in the first language into the voice in the second language.

The database 290 may store a first text corresponding to the voice in the first language and a second text obtained as the first text is translated into a text in the second language.

The database 290 may store various learning models necessary for speech recognition.

Meanwhile, the processor 180 of the AI device 10 illustrated in FIG. 2 may include the pre-processing unit 220 and the controller 230 illustrated in FIG. 3.

In other words, the processor 180 of the AI device 10 may perform a function of the pre-processing unit 220 and a function of the controller 230.

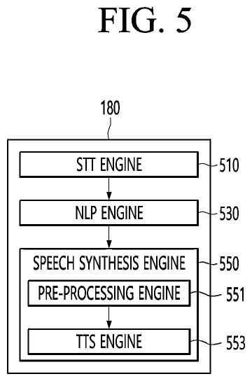

FIG. 5 is a block diagram illustrating a configuration of a processor for recognizing and synthesizing a voice in an AI device according to an embodiment of the present disclosure.

In other words, the processor for recognizing and synthesizing a voice in FIG. 5 may be performed by the learning processor 130 or the processor 180 of the AI device 10, without performed by a server.

Referring to FIG. 5, the processor 180 of the AI device 10 may include an STT engine 510, an NLP engine 530, and a speech synthesis engine 550.

Each engine may be either hardware or software.

The STT engine 510 may perform a function of the STT server 20 of FIG. 1. In other words, the STT engine 510 may convert the voice data into text data.

The NLP engine 530 may perform a function of the NLP server 30 of FIG. 1. In other words, the NLP engine 530 may acquire intention analysis information, which indicates the intention of the speaker, from the converted text data.

The speech synthesis engine 550 may perform the function of the speech synthesis server 40 of FIG. 1.

The speech synthesis engine 550 may retrieve, from the database, syllables or words corresponding to the provided text data, and synthesize the combination of the retrieved syllables or words to generate a synthetic voice.

The speech synthesis engine 550 may include a pre-processing engine 551 and a Text-To-Speech (TTS) engine 553.

The pre-processing engine 551 may pre-process text data before generating the synthetic voice.

Specifically, the pre-processing engine 551 performs tokenization by dividing text data into tokens which are meaningful units.

After the tokenization is performed, the pre-processing engine 551 may perform a cleansing operation of removing unnecessary characters and symbols such that noise is removed.

Thereafter, the pre-processing engine 551 may generate the same word token by integrating word tokens having different expression manners.

Thereafter, the pre-processing engine 551 may remove a meaningless word token (informal word; stopword).

The TTS engine 453 may synthesize a voice corresponding to the preprocessed text data and generate the synthetic voice.

A method of operating a voice service system or artificial intelligence device 10 that provides a voice synthesis service based on tone conversion is described.

The voice service system or artificial intelligence device 10 according to an embodiment of the present disclosure can generate and use a unique TTS model for voice synthesis service.

The voice service system according to an embodiment of the present disclosure can provide a platform for voice synthesis service. The voice synthesis service platform may provide a development toolkit (Voice Agent Development Toolkit) for a voice synthesis service. The voice synthesis service development toolkit may allow non-experts in voice synthesis technology to use a voice agent or voice agent according to the present disclosure. It can represent a development toolkit provided to make voice synthesis services easier to use.

Meanwhile, the voice synthesis service development toolkit according to the present disclosure may be a web-based development tool for voice agent development. This development toolkit can be used by accessing a web service through the artificial intelligence device 10, and various user interface screens related to the development toolkit can be provided on the screen of the artificial intelligence device 10.

Voice synthesis functions may include emotional voice synthesis and tone conversion functions. The voice conversion function may represent a function that allows development toolkit users to register their own voices and generate voices (synthetic voices) for arbitrary text.

While an expert in the conventional voice synthesis field generated a voice synthesis model through about 20 hours of voice data for learning and about 300 hours of learning, anyone (e.g., a general user) can use the service platform according to an embodiment of the present disclosure. Based on a relatively small amount of voice data for learning compared to the past, a unique voice synthesis model based on one's own voice can be generated through a very short learning process. In the present disclosure, for example, sentences (approximately 30 sentences) with an utterance time of 3 to 5 minutes can be used as voice data for learning, but are not limited thereto. Meanwhile, the sentence may be a designated sentence or an arbitrary sentence. Meanwhile, the learning time may be, for example, about 3-7 hours, but is not limited thereto.

According to at least one of the various embodiments of the present disclosure, a user can generate his or her own TTS model using a development toolkit and use a voice synthesis service, greatly improving convenience and satisfaction.

Voice synthesis based on timbre conversion (voice change) according to an embodiment of the present disclosure allows the speaker's timbre and vocal habits to be expressed with only a relatively small amount of learning data compared to the prior art.

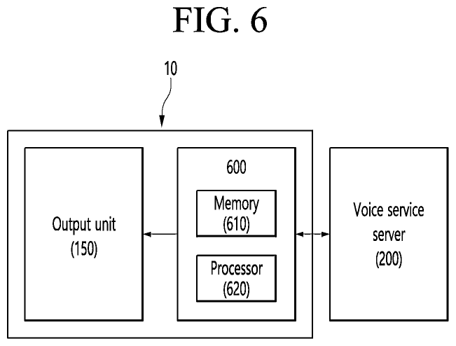

FIG. 6 is a block diagram of a voice service system for voice synthesis according to another embodiment of the present disclosure.

Referring to FIG. 6, a voice service system for voice synthesis may be configured to include an artificial intelligence device 10 and a voice service server 200.

For example, the artificial intelligence device 10 can used by a communication unit (not shown) to process a voice synthesis service through a voice synthesis service platform provided by the voice service server 200 (however, it is not necessarily limited thereto). Therefore, the artificial intelligence device 10 may be configured to include an output unit 150 and a processing unit 600.

The communication unit may support communication between the artificial intelligence device 10 and the voice service server 200. Through this, the communication unit can exchange various data through the voice synthesis service platform provided by the voice service server 200.

The output unit 150 may provide various user interface screens related to or including the development toolkit provided by the voice synthesis service platform. In addition, when a voice synthesis model is formed and stored through a voice synthesis service platform, the output unit 150 provides an input interface for receiving target data for voice synthesis, that is, arbitrary text input, and provides a user interface through the provided input interface. When voice synthesis request text data is received, voice synthesized data (i.e., synthesized voice data) can be output through a built-in or interoperable external speaker.

The processing unit 600 may include a memory 610 and a processor 620.

The processing unit 600 can process various data from the user and the voice service server 200 on the voice synthesis service platform.

The memory 610 can store various data received or processed by the artificial intelligence device 10.

The memory 610 may store various voice synthesis-related data that are processed by the processor 600, exchanged through a voice synthesis service platform, or received from the voice service server 200.

The processor 620 controls the final generated voice synthesis data (including data such as input for voice synthesis) received through the voice synthesis service platform to be stored in the memory 610, and stores the voice synthesized data stored in the memory 610. Link information (or linking information) between the synthesized data and the target user of the corresponding voice synthesized data can be generated and stored, and the information can be transmitted to the voice service server 200.

The processor 620 can control the output unit 150 to receive synthesized voice data for arbitrary text from the voice service server 200 based on link information and provide it to the user. The processor 620 may provide not only the received synthesized voice data, but also information related to recommendation information, recommendation functions, etc., or output a guide.

As described above, the voice service server 200 may include the STT server 20, NLP server 30, and voice synthesis server 40 shown in FIG. 1.

Meanwhile, regarding the voice synthesis processing process between the artificial intelligence device 10 and the voice service server 200, refer to the content disclosed in FIGS. 1 to 5 described above, and redundant description will be omitted here.

According to an embodiment, at least a part or function of the voice service server 200 shown in FIG. 1 may be replaced by an engine within the artificial intelligence device 10 as shown in FIG. 5.

Meanwhile, the processor 620 may be the processor 180 of FIG. 2, but may also be a separate configuration.

In this disclosure, for convenience of explanation, only the artificial intelligence device 10 may be described, but it may be replaced by or include the voice service server 200 depending on the context.

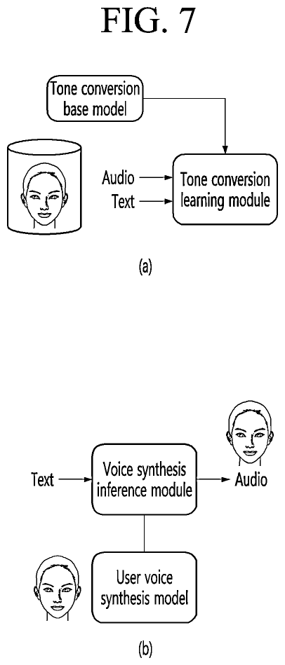

FIG. 7 is a schematic diagram illustrating a voice synthesis service based on timbre conversion according to an embodiment of the present disclosure.

Voice synthesis based on timbre conversion according to an embodiment of the present disclosure may largely include a learning process (or training process) and an inference process.

First, referring to (a) of FIG. 7, the learning process can be accomplished as follows.

The voice synthesis service platform may generate and maintain a tone conversion base model in advance to provide a tone conversion function.

When voice data for voice synthesis and corresponding text data are input from a user, the voice synthesis service platform can learn them in a tone conversion learning module.

Learning can be done through, for example, speaker transfer learning on a pre-owned tone conversion base model. In the present disclosure, the amount of voice data for learning is a small amount of voice data compared to the prior art, for example, the amount of voice data corresponding to about 3 to 7 minutes, and learning can be performed for a period of time within 3 to 7 hours.

Next, referring to (b) of FIG. 7, the inference process can be performed as follows.

The inference process shown in (b) of FIG. 7 may be performed, for example, after learning in the tone conversion learning module described above.

For example, the voice synthesis service platform may generate a user voice synthesis model for each user through the learning process in (a) of FIG. 7.

When text data is input, the voice synthesis service platform can determine the target user for the text data and generate synthetic data through an inference process in the voice synthesis inference module based on the user voice synthesis model previously generated for the determined target user to produce a voice for the target user.

However, the learning process in (a) of FIG. 7 and the inference process in (b) of FIG. 7 according to an embodiment of the present disclosure are not limited to the above-described content.

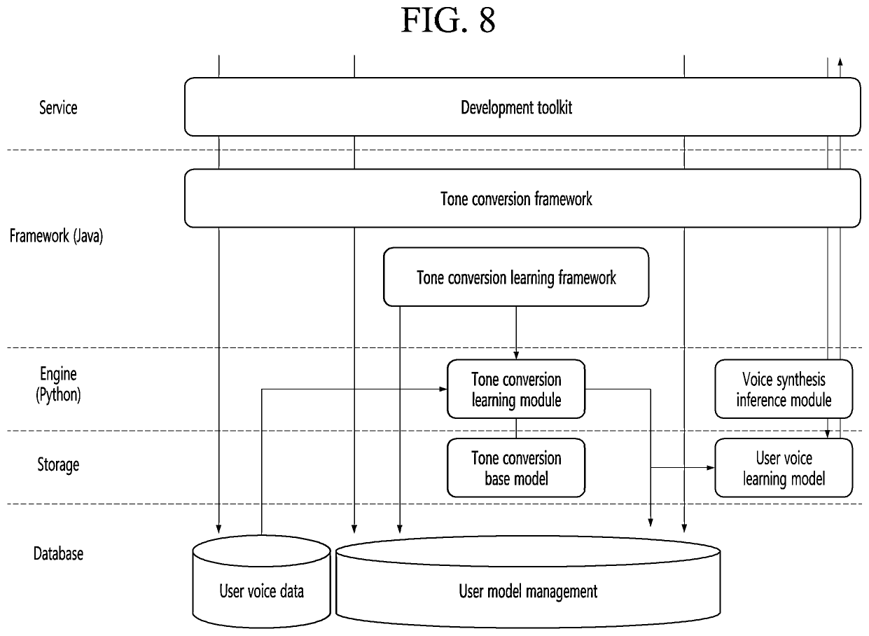

FIG. 8 is a diagram illustrating the configuration of a voice synthesis service platform according to an embodiment of the present disclosure.

Referring to FIG. 8, the voice synthesis service platform can be formed as a hierarchical structure consisting of a database layer, a storage layer, an engine layer, a framework layer, and a service layer, but is not limited to thereto.

Depending on the embodiment, at least one layer may be omitted or combined to form a single layer in the hierarchical structure shown in FIG. 8 constituting the voice synthesis service platform.

In addition, the voice synthesis service platform may be formed by further including at least one layer not shown in FIG. 8.

With reference to FIG. 8, each layer constituting the voice synthesis service platform is described as follows.

The database layer may hold (or include) a user voice data DB and a user model management DB to provide voice synthesis services in the voice synthesis service platform.

The user voice data DB is a space for storing user voices, and each user voice (i.e., voice) can be individually stored. Depending on the embodiment, the user voice data DB may have multiple spaces allocated to one user, and vice versa. In the former case, the user voice data DB may be allocated a plurality of spaces based on a plurality of voice synthesis models generated for one user or text data requested for voice synthesis.

For example, the user voice data DB can register each user's sound source (voice) through a development toolkit provided in the service layer, that is, when the user's sound source data is uploaded, it can be stored in a space for that user.

Sound source data can be received and uploaded directly from the artificial intelligence device 10 or indirectly uploaded through the artificial intelligence device 10 through a remote control device (not shown). Remote control devices may include mobile devices such as smartphones installed with remote controls, applications related to voice synthesis services, API (Application Programming Interface), plug-ins, etc., but is not limited to thereto.

For example, the user model management DB stores information (target data, related motion control information, etc.) when a user voice model is generated, learned, or deleted by the user through the development toolkit provided in the service layer.

The user model management DB can store information about sound sources, models, learning progress, etc. managed by the user.

For example, the user model management DB can store related information when a user requests to add or delete a speaker through a development toolkit provided in the service layer. Therefore, the user's model can be managed through the user model management DB.

The storage layer may include a tone conversion base model and a user voice synthesis model.

The tone conversion base model may represent a basic model (common model) used for tone conversion.

The user voice synthesis model may represent a voice synthesis model generated for the user through learning in a timbre conversion learning module.

The engine layer may include a tone conversion learning module and a voice synthesis inference module, and may represent an engine that performs the learning and inference process as shown in FIG. 7 described above. At this time, the module (engine) belonging to the engine layer may be written based on, for example, Python, but is not limited to thereto.

Data learned through the tone conversion learning module belonging to the engine layer can be transmitted to the user voice synthesis model of the storage layer and the user model management DB of the database layer, respectively.

The tone conversion learning module can start learning based on the tone conversion base model in the storage layer and the user voice data in the database layer. The tone conversion learning module can perform speaker transfer learning to suit a new user's voice based on the tone conversion base model.

The tone conversion learning module can generate a user voice synthesis model as a learning result. The tone conversion learning module can generate multiple user voice synthesis models for one user.

Depending on the embodiment, when a user voice synthesis model is generated as a learning result, the tone conversion learning module may generate a model similar to the user voice synthesis model generated according to a request or setting. At this time, the similar model may be one in which some predefined parts of the initial user voice synthesis model have been arbitrarily modified and changed.

According to another embodiment, when one user's voice synthesis model is generated as a learning result, the tone conversion learning module may combine it with another user's previously generated voice synthesis model for the corresponding user to generate a new voice synthesis model. Depending on the user's parasitic-generated voice synthesis model, various new voice synthesis models can be combined and generated.

Meanwhile, newly combined and generated voice synthesis models (above similar models) can be linked or mapped to each other by assigning identifiers, or stored together, so that recommendations can be provided when there is a direct request from the user or when a related user voice synthesis model is called.

When the tone conversion learning module completes learning, it can save learning completion status information in the user model management DB.

The voice synthesis inference module can receive a request for voice synthesis for text along with text from the user through the voice synthesis function of the development toolkit of the service layer. When a voice synthesis request is received, the voice synthesis inference module can generate a synthesized voice together with the user voice synthesis model on the storage layer, that is, the user voice synthesis model generated through the timbre conversion learning module, and return or deliver it to the user through the development toolkit. Delivered through a development toolkit may mean provided to the user through the screen of the artificial intelligence device 10.

The framework layer may be implemented including, but is not limited to, a tone conversion framework and a tone conversion learning framework.

The timbre conversion framework is based on Java and can transfer commands and data between the development toolkit, engine, and database layers. The tone conversion framework may utilize RESTful API in particular to transmit commands, but is not limited to this.

When a user's sound source is registered through the development toolkit provided in the service layer, the tone conversion framework can transfer it to the user's voice data DB in the database layer.

When a learning request is registered through the development toolkit provided in the service layer, the tone conversion framework can transfer it to the user model management DB in the database layer.

When a request to check the model status is received through the development toolkit provided in the service layer, the tone conversion framework can forward it to the user model management DB in the database layer.

When a voice synthesis request is registered through the development toolkit provided in the service layer, the voice conversion framework can forward it to the voice synthesis inference module in the engine layer. The voice synthesis inference module can pass this back to the user voice synthesis model in the storage layer.

The tone conversion learning framework can periodically check whether a learning request is received by the user.

The tone conversion learning framework can also automatically start learning if there is a model to learn.

When a learning request is registered in the framework layer through the development toolkit provided in the service layer, the tone conversion learning framework can send a confirmation signal to the user model management DB of the database layer as to whether the learning request has been received.

The tone conversion learning framework can control the tone conversion learning module of the engine layer to start learning according to the content returned from the user model management DB in response to the transmission of a confirmation signal as to whether the above-described learning request has been received.

When learning is completed according to the learning request or control of the timbre conversion learning framework, the timbre conversion learning module can transfer the learning results to the user voice synthesis model in the storage layer and the user model management in the database layer, as described above.

The service layer may provide a development toolkit (user interface) of the above-described voice synthesis service platform.

Through the development toolkit of this service layer, users can manage user information, register sound sources (voices) that are the basis of voice synthesis, check sound sources, manage sound source models, register learning requests, request model status confirmation, request voice synthesis and provide results, etc. A variety of processing can be performed. The development toolkit may be provided on the screen of the artificial intelligence device 10 when the user uses the voice synthesis service platform through the artificial intelligence device 10.

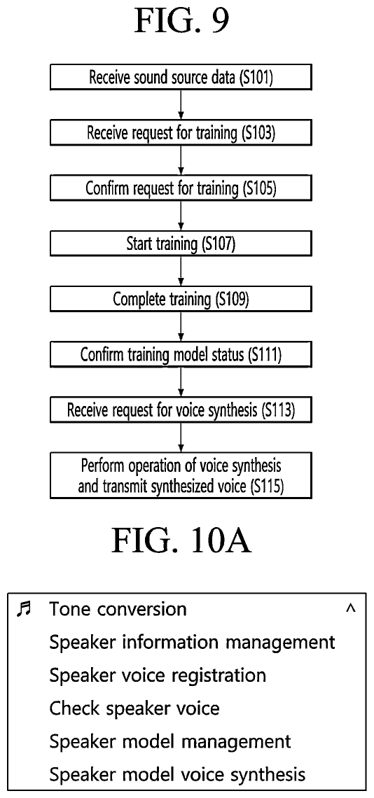

FIG. 9 is a flow chart illustrating a voice synthesis service process according to an embodiment of the present disclosure.

The voice synthesis service according to the present disclosure is performed through a voice synthesis service platform, but in the process, various data may be transmitted/received between the hardware artificial intelligence device 10 and the server 200.

For convenience of explanation, FIG. 9 illustrates the operation of the server 200 through the voice synthesis service platform, but is not limited thereto.

The server 200 can provide a development toolkit for the user's convenience in using the voice synthesis service to be output on the artificial intelligence device 10 through the voice synthesis service platform. At least one or more of the processes shown in FIG. 9 may be performed on or through a development toolkit.

When the user's sound source data and learning request are registered on the voice synthesis service platform (S101, S103), the server 200 can check the registered learning request (S105) and start learning (S107).

When learning is completed (S109), the server 200 can check the status of the generated learning model (S111).

When a voice synthesis request is received through the voice synthesis service platform after step S111 (S113), the server 200 may perform an operation for voice synthesis based on the user voice synthesis model and the voice synthesis inference model and transmit the synthesized voice. (S115).

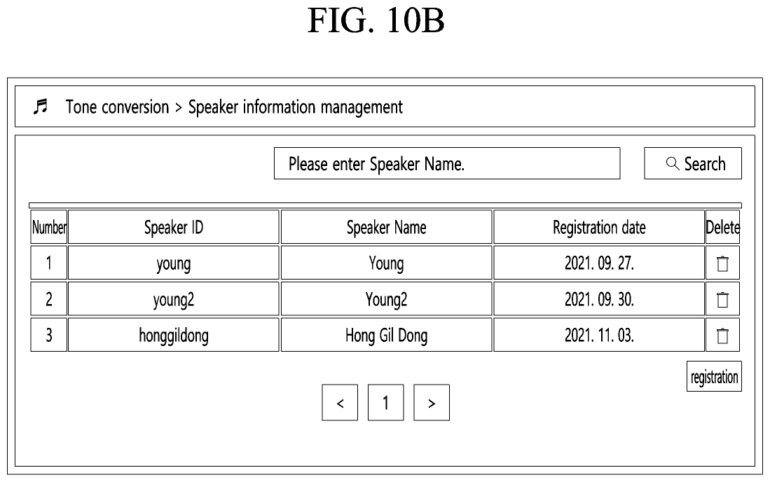

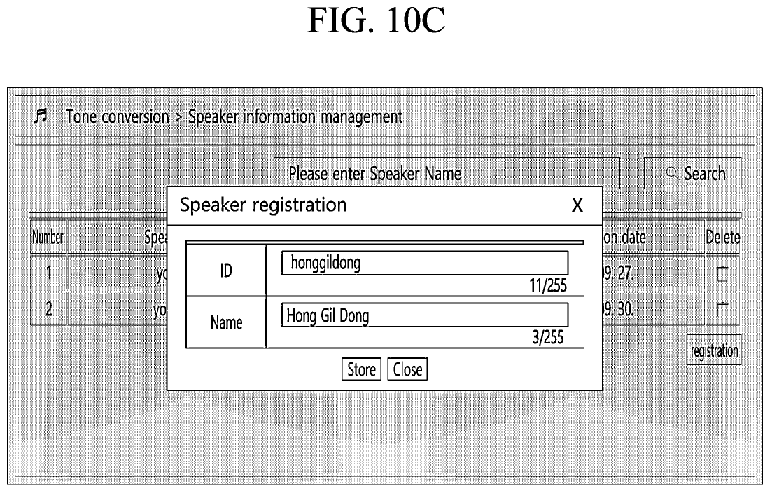

FIGS. 10A to 15D are diagrams to explain a process of using a voice synthesis service on a service platform using a development toolkit according to an embodiment of the present disclosure.

Hereinafter, the development toolkit will be described as a user interface for convenience.

FIG. 10A illustrates a user interface for functions available through a development toolkit for a voice synthesis service according to an embodiment of the present disclosure.

Referring to FIG. 10A, various functions such as speaker information management, speaker voice registration, speaker voice confirmation, speaker model management, and speaker model voice synthesis are available through the development toolkit.

FIGS. 10B and 10C show a user interface for the speaker information management function among the functions available through the development toolkit of FIG. 10A.

Referring to FIG. 10B, pre-registered speaker information may be listed and provided. At this time, the speaker information may include information about the speaker ID (or identifier), speaker name, speaker registration date, etc.

FIG. 10C may show a screen for registering a new speaker through the registration button in FIG. 10B. As described above, one speaker can register multiple speakers.

Next, a user interface related to speaker voice registration is shown among the functions available through the development toolkit for voice synthesis service according to an embodiment of the present disclosure.

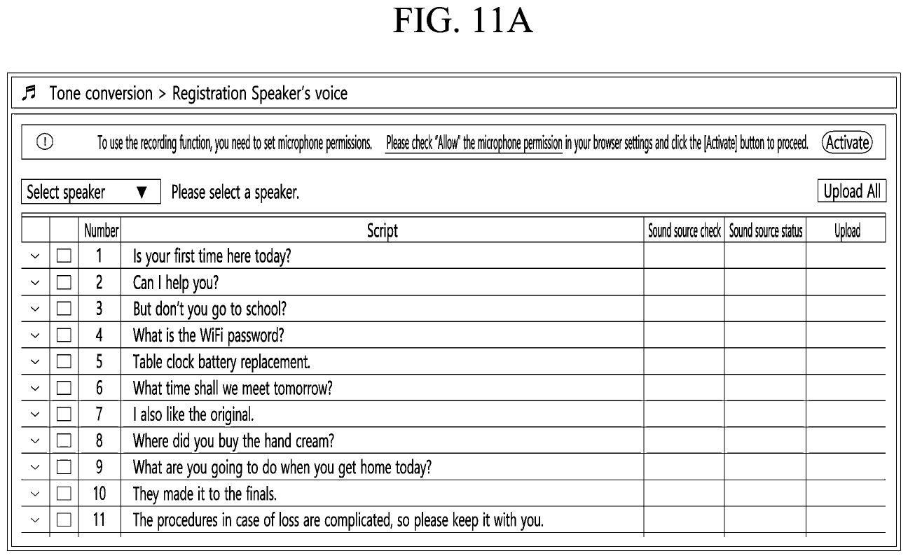

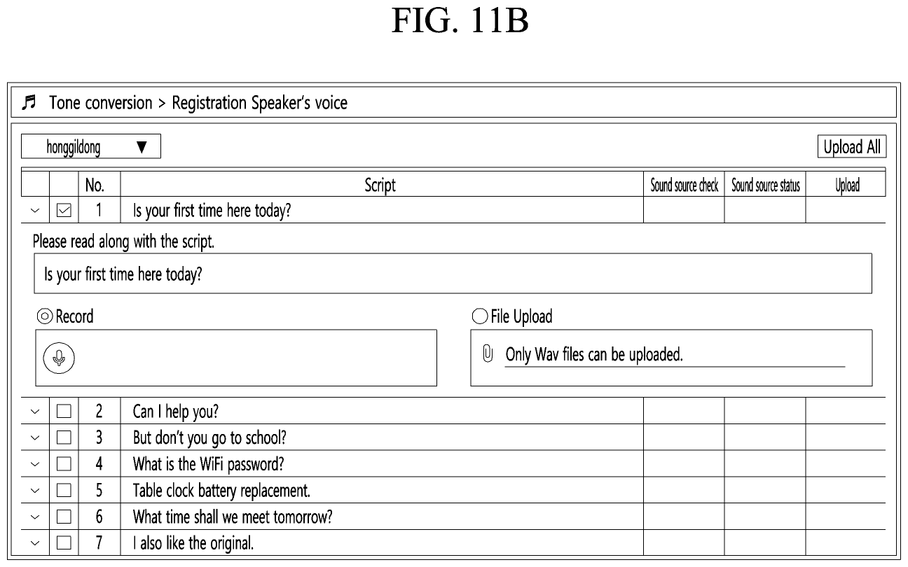

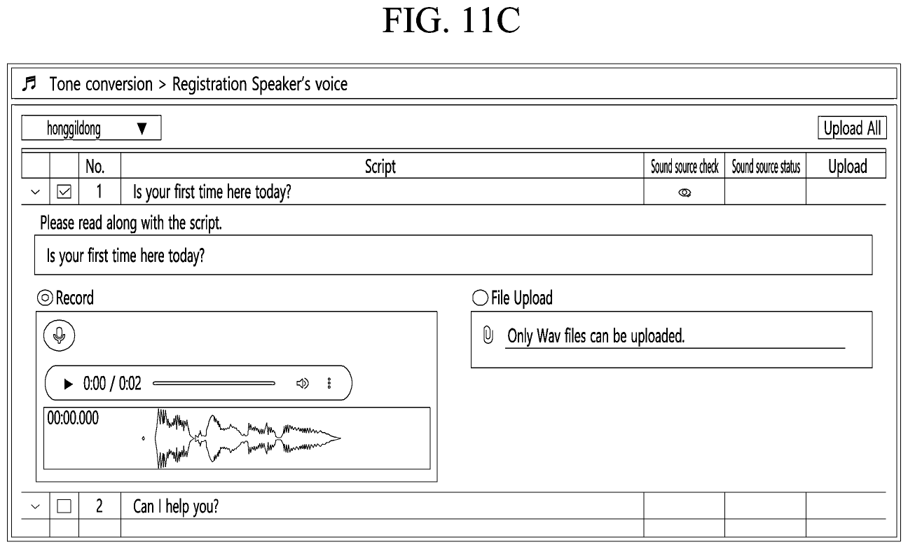

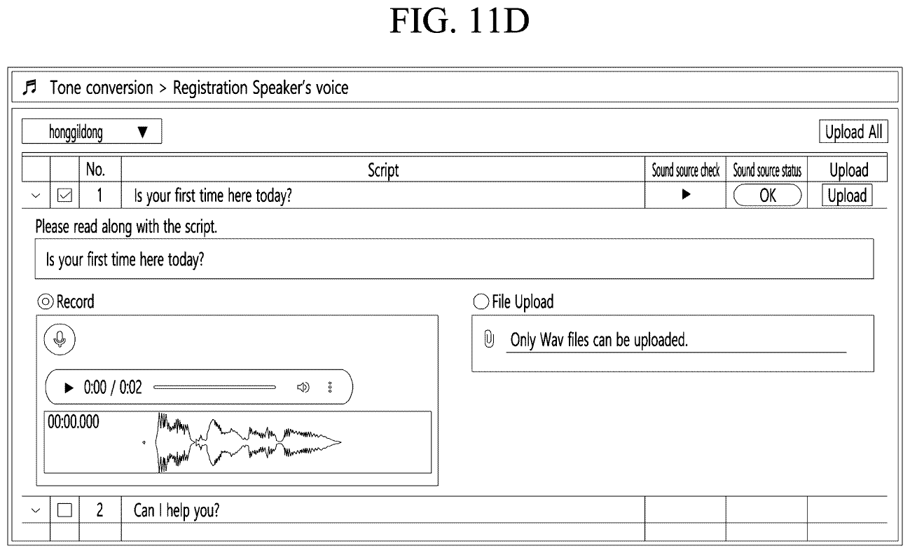

FIG. 11A shows a designated text list for registering a speaker's sound source (voice) for voice synthesis.

In the above-described embodiment, it is exemplified that sound source registration for at least 10 designated test texts is required to register the speaker's sound source for voice synthesis, but the present invention is not limited to this. That is, the speaker (user) can select a plurality of arbitrary test texts from the text list shown in FIG. 11A and record and register the sound source for the test texts.

Depending on the embodiment, the test text list shown in FIG. 11A may be registered by the speaker recording sound sources in that order.

FIG. 11B illustrates the recording process for the test text list selected in FIG. 11A.

When a speaker is selected on the user interface shown in FIG. 11A and a desired test text list is selected, the screen of FIG. 11B may be provided. However, in this case, when a speaker is selected, the test text list may be automatically selected and immediately converted to the screen of FIG. 11B.

Referring to FIG. 11B, one test text is provided, recording may be requested as the record button is activated, and when recording is completed by the speaker, an item for uploading the recording file to the server 200 may be provided.

In FIG. 11C, when the item (recording function) is activated and the speaker speaks the given test text, the recording time and sound source waveform information of the recorded speaker can be provided. At this time, test text data according to the utterance may also be provided to check whether the text uttered by the speaker matches the test text. Through this, it can be determined whether the provided test text matches the uttered text.

Depending on the embodiment, in FIG. 11C, the server 200 may request the speaker to repeatedly utter the test text multiple times. Through this, the server 200 can determine whether the sound source waveform according to the speaker's utterance matches each time.

Depending on the embodiment, the server 200 may request the speaker to utter different nuances for the same test text, or may request utterances of the same nuance.

In the latter case, the server 200 compares the sound source waveforms obtained by the speaker's utterance for the same test text, and excludes from the count or does not adopt the utterance corresponding to the sound source waveform in which the sound source waveform differs by more than a threshold value.

The server 200 may calculate an average value for the sound source waveform obtained by the speaker uttering the same test text a predefined number of times. The server 200 may define the maximum allowable value and minimum allowable value based on the calculated average value. Once the average value, maximum allowable value, and minimum allowable value are defined in this way, the server 200 can reconfirm the defined value by testing the values.

Meanwhile, if the sound source waveform according to the test results continues to deviate from the maximum allowable value and minimum allowable value more than a predetermined number of times based on the defined average value, the server 200 may redefine the predefined average value, maximum allowable value, and minimum allowable value.

According to another embodiment, the server 200 may generate a sound source waveform in which the maximum allowable value and minimum allowable value are taken into account based on the average value of the text data, and overlap the corresponding sound source waveform and the test sound source waveform to generate a sound source waveform. In this case, the server 200 may filter and remove the portion of the sound source waveform that corresponds to silence or a sound source waveform of less than a predefined size and determine whether the sound source waveforms match by comparing only meaningful sound source waveforms.

In FIG. 11D, when the speaker's sound source registration for one test text is s completed, the server 200 provides information on whether the sound source is in good condition and provides services so that the speaker can upload the corresponding sound source information.

Unlike what was described above, the following describes the process of providing an error message and requesting re-voice, for example, when sound source confirmation is requested in the process of registering the speaker's sound source and an error occurs as a result of the sound source confirmation.

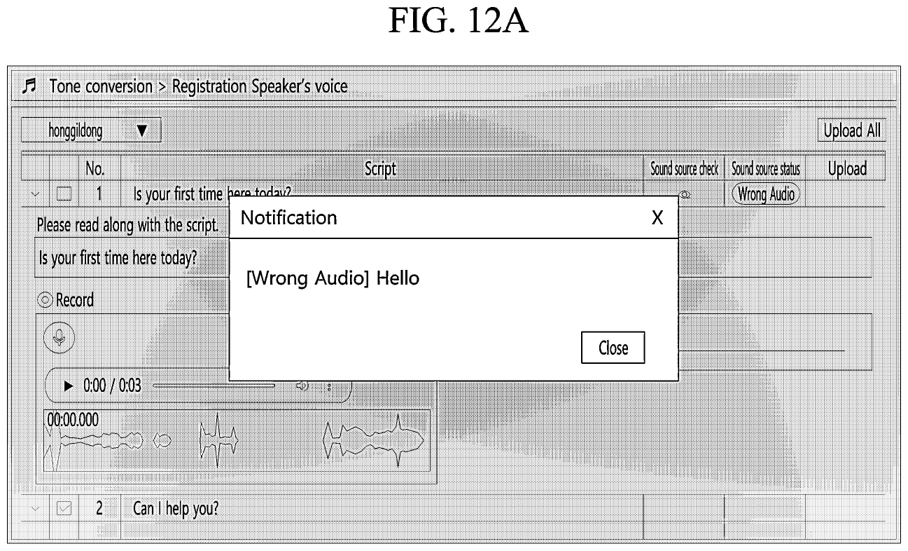

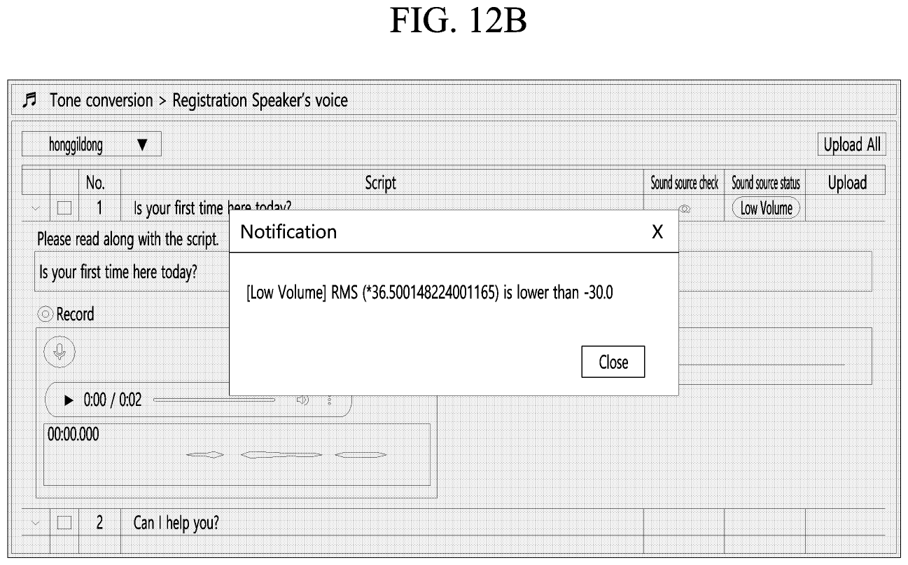

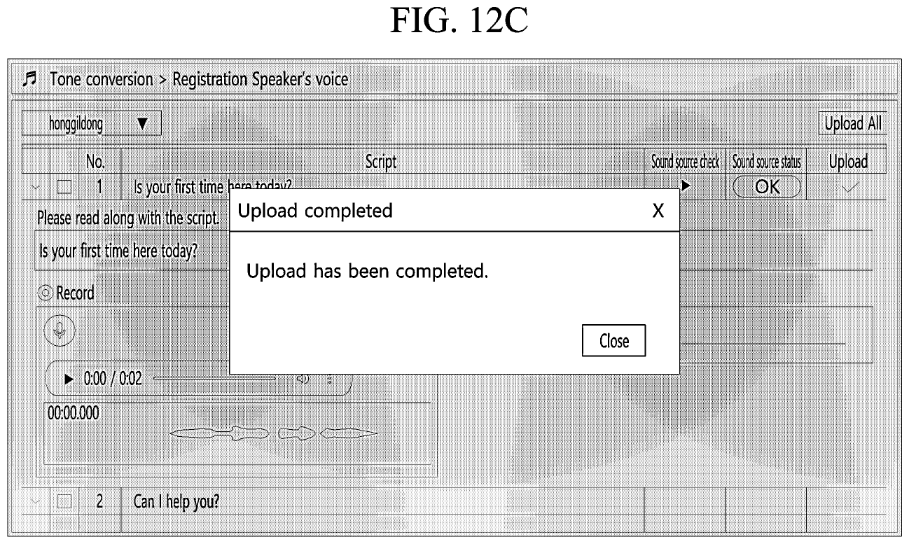

For example, when ‘I guess this is your first time here today?’ is provided as the test text, the server 200 may provide an error message as shown in FIG. 12A if the speaker utters the text ‘Hello’ rather than the test text.

On the other hand, unlike FIG. 12A, if a sound source corresponding to the same text as the test text is uttered, but the intensity of the sound source is less than the threshold, an error message may be provided as shown in FIG. 12B.

The threshold may be −30 dB, for example. However, it is not limited to this. For example, if the intensity of the speaker's spoken voice for the test text is −35.6 dB, since this is less than the aforementioned threshold of −30 dB, the server 200 may provide an error message called ‘Low Volume’. At this time, the intensity of the recorded voice, that is, the size of the volume, can be expressed as RMS (Root Mean Square), and through this, it is possible to identify how much the volume is smaller than expected.

However, in the case of FIGS. 12A and 12B, the server 200 may provide information so that the speaker can clearly recognize what error has occurred.

In FIG. 12C, if the error in FIGS. 12A and 12B is resolved or upload is requested after the process of FIGS. 11A to 12D, the server 200 may be notified that the speaker's sound source for the test text has been uploaded.

In addition, rather than recording and registering the speaker's utterance of the test text directly through the service platform, if the speaker's sound source file exists on another device, the speaker can call and register it through the service platform. In this case, legal problems such as theft of music may arise, so appropriate protection measures need to be taken. For example, when a speaker calls and uploads a sound source file stored in another device, the server 200 can determine whether the sound source corresponds to the test text. As a result of the determination, if the sound source corresponds to the test text, the server 200 can determine, request the speaker's sound source for the test text again, determine whether the sound source waveform of the requested sound source and the uploaded sound source match or at least have a difference less than a threshold, and only if they match or are within a predetermined range, the speaker's sound source It is judged to be a sound source and registered, but if not, registration may be rejected despite upload. Through this method, it is possible to respond to legal regulations on music theft. The server 200 can provide a notice with legal effect regarding the call in advance before rejecting registration, that is, before the speaker calls the sound source file stored in another device through the service platform, and provide the sound source file only when the speaker consents. A service is available to enable uploading.

Depending on the embodiment, if there is no legal issue such as sound source theft when registering a sound source file of another device through a service platform, the server 200 may call and register the voice of another person other than the speaker's voice if it is uploaded.

The server 200 registers the speaker's sound source file for each test text through the service platform, and once the file is generated, the file can be uploaded in bulk or all, or service control can be performed so that only a portion of the file is selected and uploaded.

The server 200 can control the service to upload and register a plurality of speakers' sound source files for each test text through the service platform. Each of the plurality of uploaded files may have different sound source waveforms depending on the emotional state or nuance of the speaker for the same test text.

Next, the process of confirming the speaker's sound source through the service platform according to an embodiment of the present disclosure will be described.

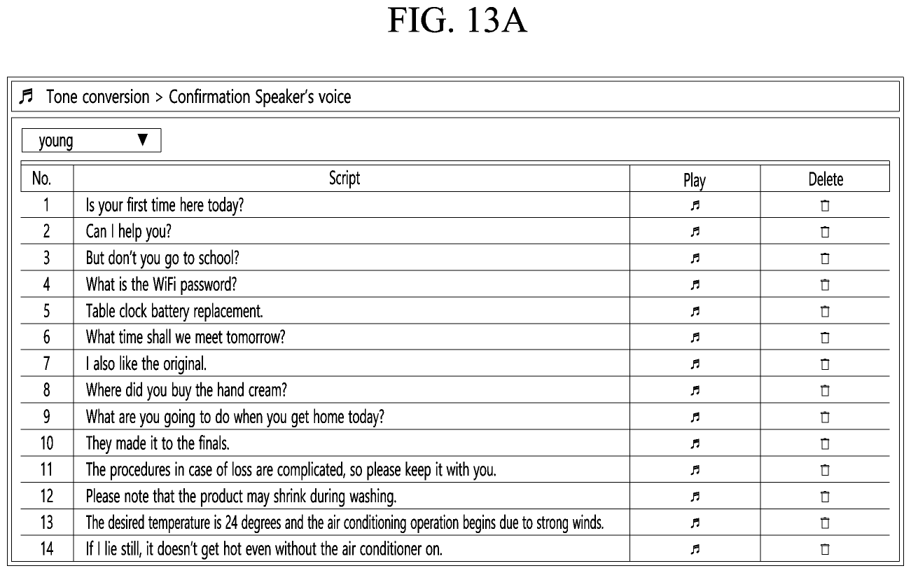

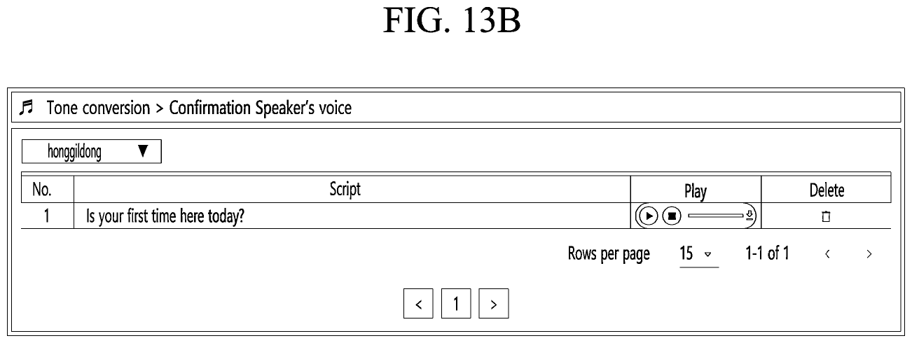

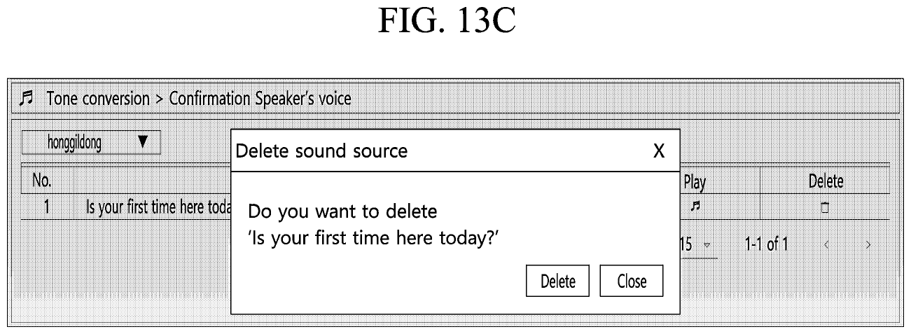

The user interface of FIG. 13A shows a list of sound sources registered by the speaker. As shown in FIG. 13A, the server 200 can provide service control so that the speaker can play or delete the registered sound source for each test text directly uploaded and registered by the speaker.

Referring to FIG. 13B, when a sound source is selected by a speaker, the server 200 may provide a playback bar for playing the corresponding test text and sound source. The server 200 may provide a service that allows the speaker to check the sound source he or she has registered through a play bar. The server 200 may provide a service that allows the speaker to re-record, re-upload, and re-register the sound source for the test text through the above-described process depending on the confirmation result, or immediately delete it as shown in FIG. 13C.

Next, a process for managing a speaker model in the server 200 through a service platform according to an embodiment of the present disclosure will be described.

Speaker model management may be, for example, a user interface for managing a speaker voice synthesis model.

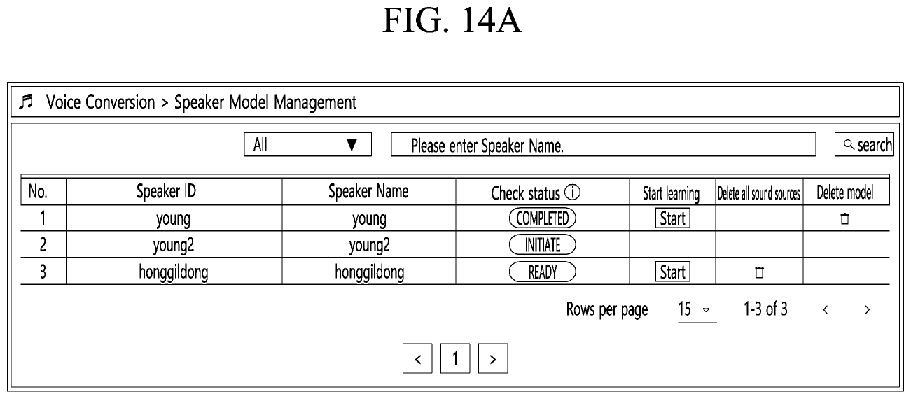

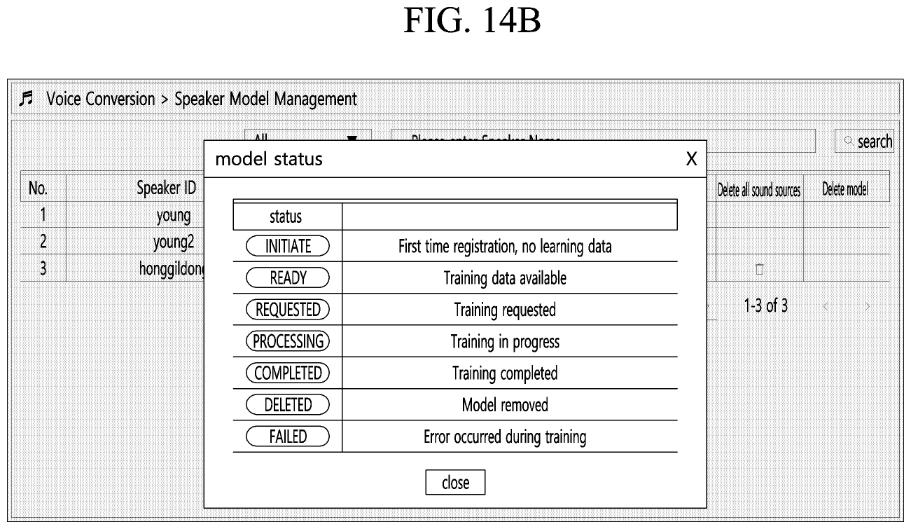

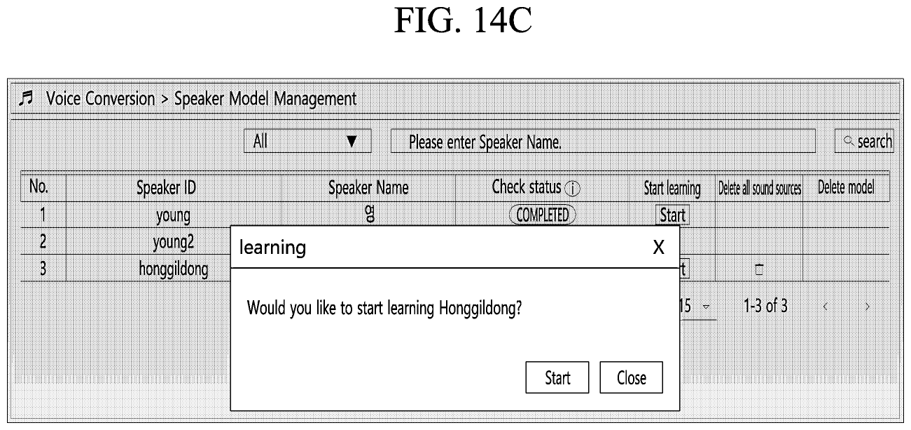

Through the user interface shown in FIG. 14A, the server 200 can start learning a model with each speaker ID, and can also delete already learned models or registered sound sources.

Referring to FIGS. 14A and 14B, the server 200 may provide a service so that the speaker can check the progress of the speaker's voice synthesis model by checking the learning progress of the speaker's voice synthesis model.

In particular, in FIG. 14B, the learning progress status of the model can be displayed as follows. For example, FIG. 14B illustrates the INITIATE state indicating that there is no learning data in the first registered state, the READY state indicating that there is learning data, the REQUESTED state indicating when learning has been requested, the PROCESSING state indicating when learning is complete, and the state where learning has been completed. Services can be provided to enable status checks such as the COMPLETED state indicating a case, the DELETED state indicating a case where a model has been removed, and the FAILED state indicating a case where an error occurred during learning.

Therefore, referring again to FIG. 14A, if there is learning data for a speaker whose speaker ID is ‘Hong Gil-dong’, the server 200 can provide the service so that the ‘READY’ status is displayed. In this case, when the status check item for the speaker with the speaker ID ‘Hong Gil-dong’ is selected, the server 200 may provide a guidance message as shown in FIG. 14C. The guidance message may vary depending on the status of the speaker with the corresponding speaker ID. Referring to FIGS. 14A and 14C, the server 200 may provide a guidance message so that the speaker with the speaker ID ‘Hong Gil-dong’ is currently in the ‘READY’ state, so that he can request the next state, that is, start learning. When the server 200 receives a request to start learning through the corresponding information message from the speaker, it changes the speaker's status from ‘READY’ to ‘REQUESTED’ and starts learning in the tone conversion learning module, the server 200 can be changed to PROCESSING state, which displays the state during learning. Afterwards, when learning is completed in the tone conversion learning module, the server 200 may automatically change the speaker's status from ‘PROCESSING’ to ‘COMPLETED’.

Lastly, the process of voice synthesis of a speaker model through a service platform according to an embodiment of the present disclosure will be described.

The user interface for speaker model voice synthesis may be for, for example, when voice synthesis is performed next when learning has been completed (COMPLETED) upon request in the tone conversion learning module.

The illustrated user interface may be for at least one speaker ID that has been learned through the above-described process.

Referring to the illustrated user interface, at least one the items may be included such as items to select speaker ID (or speaker name), items to select/change text to perform voice synthesis, synthesis request item, synthesis method control item, item on whether to play, download, or delete.

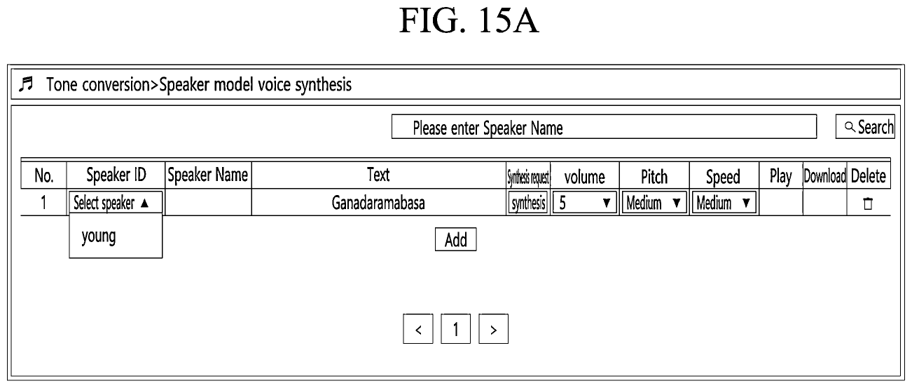

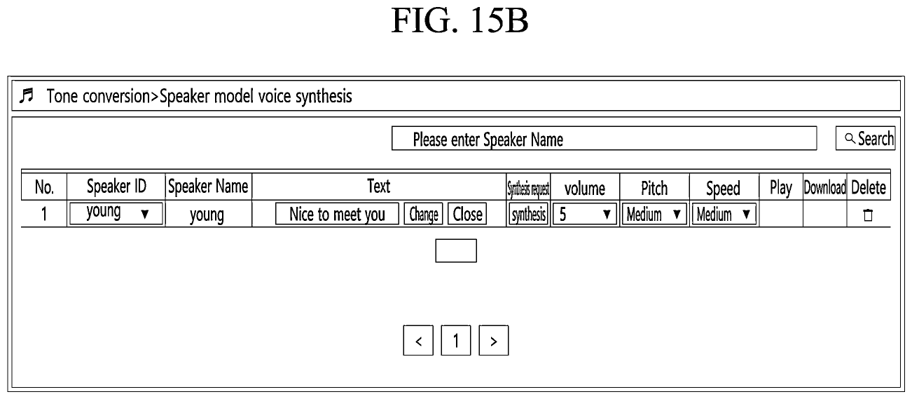

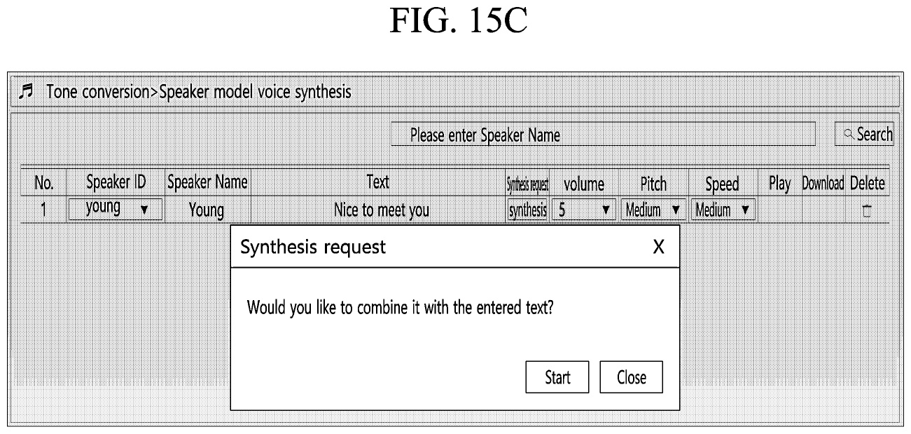

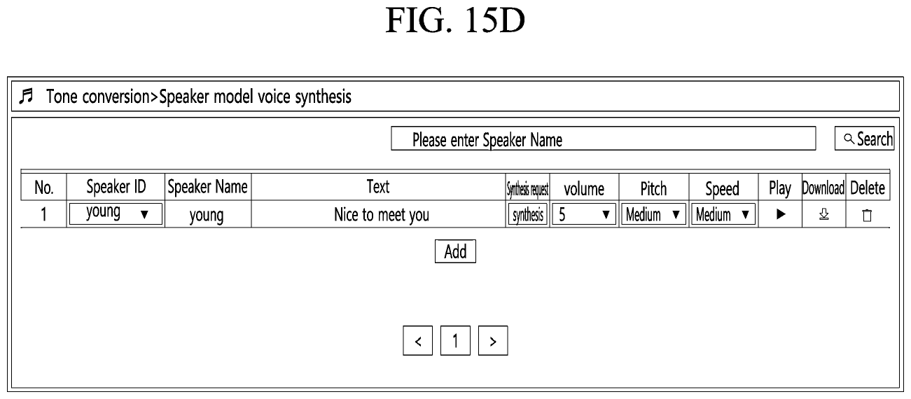

FIG. 15A is a user interface screen for selecting a speaker who can start voice synthesis. At this time, when the speaker ID item is selected, the server 200 may provide selectable at least one speaker ID for which learning by the tone conversion learning module has been completed so that voice synthesis can begin.

FIG. 15B is a user interface screen for selecting or changing the voice synthesis text desired by the speaker with the corresponding speaker ID, that is, the target text for voice synthesis.

‘Ganadaramavasa’ displayed in the corresponding item in FIG. 15A is only an example of a text item and is not limited thereto.

When a speaker ID is selected in FIG. 15A, the server 200 may activate a text item to provide a text input window, as shown in FIG. 15B.

Depending on the embodiment, the server 200 may provide a blank screen so that the speaker can directly input text into the text input window, or a text set as default or a text randomly selected from among texts commonly used in voice synthesis. Any one of these services can be provided. Meanwhile, even when the text input window is activated, not only an interface for text input such as a keyboard but also an interface for voice input can be provided, and the voice input through this can be STT processed and provided to the text input window.

When an input such as at least one letter or vowel/consonant is entered into the text input window, the server 200 may recommend keywords or text related to the input such as auto-completion.

When text input is completed in the text input window, the server 200 can be controlled to complete text selection for voice synthesis by selecting a change or close button.

In FIG. 15B, when the synthesis request function is called after text selection, the server 200 can provide a guidance message as shown in FIG. 15C, and voice synthesis can start according to the speaker's selection.

FIG. 15D may be performed between FIGS. 15B and 15C, or may be performed after the process of FIG. 15C. For convenience, it is explained as the latter.

When voice synthesis is started and completed for the text requested by the corresponding speaker ID through the process of FIG. 15C, the server 200 may select the play button or listen to the synthesized voice as shown in FIG. 15D, or click the download button. can select to download the sound source for the synthetic voice, or can select the delete button to delete the sound source generated for the synthetic voice.

In addition, the server 200 may provide a service that allows adjustment of synthesized voice for text for which voice synthesis has been completed by the speaker. For example, the server 200 may adjust the volume level, pitch, and speed as shown in FIG. 15D. Regarding the adjustment of the volume level, the volume level is set to the middle value by default (for example, if the volume level is 1-10, 5), but the volume level (5) of the first synthesized voice is set as the default. It can be adjusted arbitrarily within the level control range (1-10). When adjusting the volume level, the convenience of adjusting the volume level can be improved by immediately executing and providing a synthesized voice according to the volume level adjustment. Pitch adjustment, for example, may be set to a default value of Medium for the first synthesized voice, but can be changed to an arbitrary value (one of Lowest, Low, High, and Highest). In this case as well, the pitch value at which the synthesized voice has been adjusted is provided simultaneously with the pitch adjustment, thereby increasing the convenience of pitch adjustment. Additionally, regarding speed adjustment, the default value (Medium) may be set for the first synthesized voice, but this can be adjusted to an arbitrary speed value (one of Very Slow, Slow, Fast, and Very Fast).

In the above, the volume level may be provided to be selectable in a non-numeric manner. Conversely, pitch and speed control values can also be provided in numerical form.

Depending on the embodiment, a synthesized voice adjusted according to a request for adjustment of at least one of volume, pitch, and speed with respect to the first synthesized voice may be stored separately with the first synthesized voice, but may be linked to the first synthesized voice.

Synthetic voices adjusted according to requests for adjustment of at least one of volume, pitch, and speed are applied only when playing on the service platform, and in the case of downloading, the service may be provided so that only the initial synthesized voice with the default value can be downloaded. It is not limited to this. In other words, it may be applicable even when downloading.

According to another embodiment, the basic volume, basic pitch, and basic speed values before the synthesis request may vary according to preset. Each of the above values can be arbitrarily selected or changed. Additionally, each of the above values can be applied when requesting synthesis as a pre-mapped value according to the speaker ID.

As described above, according to at least one of the various embodiments of the present disclosure, a user can have his or her own unique voice synthesis model, which can be utilized on various social media or personal broadcasting platforms. Additionally, personalized voice synthesizers can be used for virtual spaces or virtual characters, such as digital humans or the metaverse.

Even if not specifically mentioned, the order of at least some of the operations disclosed in this disclosure may be performed simultaneously, may be performed in an order different from the previously described order, or some may be omitted/added. According to an embodiment of the present invention, the above-described method can be implemented as processor-readable code on a program-recorded medium. Examples of media that the processor can read include ROM, RAM, CD-ROM, magnetic tape, floppy disk, and optical data storage devices.

The artificial intelligence device described above is not limited to the configuration and method of the above-described embodiments, but the embodiments are configured by selectively combining all or part of each embodiment so that various modifications can be made.

### INDUSTRIAL APPLICABILITY

According to the voice service system according to the present disclosure, it provides a personalized voice synthesis model and can be used in various media environments by utilizing the user's unique synthesized voice, so it has industrial applicability.

What is claimed is:

1. A method of providing voice synthesis service, comprising:
receiving sound source data for synthesizing a speaker's voice for a plurality of predefined first texts through a voice synthesis service platform that provides a development toolkit;
learning tone conversion for the speaker's sound source data using a pre-generated tone conversion base model;
generating a voice synthesis model for the speaker through learning the tone conversion;
being inputted second text;
generating a voice synthesis model through voice synthesis inference based on the voice synthesis model for the speaker and the second text; and
generating a synthesized voice using the voice synthesis model.

2. The method of claim 1, wherein the step of receiving sound source data for synthesizing the speaker's voice for the plurality of predefined first texts includes:
receiving the speaker's sound source multiple times for each first text; and
generating sound source data for synthesizing the speaker's voice based on the speaker's sound source input multiple times.

3. The method of claim 2, wherein the sound source data for voice synthesis of the speaker is an average value of the speaker's sound source input multiple times.

4. The method of claim 3, wherein the step of learning the tone conversion includes performing speaker transfer learning based on the tone conversion base model.

5. The method of claim 1, wherein a plurality of the voice synthesis model is generated for the speaker.

6. The method of claim 1, wherein only the first text selected from the plurality of predefined first text is used for the voice synthesis.

7. The method of claim 1, further comprises:
receiving a speaker ID and third text;
calling the generated voice synthesis model for the speaker corresponding to the speaker ID;
synthesizing voice for the third text based on the called voice synthesis model; and
generating a synthesized voice for the third text.

8. The method of claim 7, further comprises:
receiving an input for at least one of volume level, pitch, and speed for the generated synthesized voice; and
adjusting one of a volume level, pitch, and speed for the generated synthesized voice based on the received input.

9. An artificial intelligence-based voice synthesis service system, comprising:
an artificial intelligence device; and
a computing device configure to exchanges data with the artificial intelligence device,
wherein the computing device includes:
a processor configured to:
receive sound source data for synthesizing a speaker's voice for a plurality of predefined first texts through a voice synthesis service platform that provides a development toolkit, learn tone conversion for the speaker's sound source data using a pre-generated tone conversion base model, generate a voice synthesis model for the speaker through learning the tone conversion, when being inputted second text, generate a voice synthesis model through voice synthesis inference based on the voice synthesis model for the speaker and the second text, and generate a synthesized voice using the voice synthesis model.

10. The artificial intelligence-based voice synthesis service system of claim 9, wherein the processor is configured to receive the speaker's sound source multiple times for each first text, and generate sound source data for synthesizing the speaker's voice based on the speaker's sound source input multiple times.

11. The artificial intelligence-based voice synthesis service system of claim 10, wherein the processor is configured to set sound source data for voice synthesis of a commercial speaker as the average value of the speaker's sound source input multiple times.

12. The artificial intelligence-based voice synthesis service system of claim 11, wherein the processor is configured to learn the tone conversion by performing speaker transfer learning based on the tone conversion base model.

13. The artificial intelligence-based voice synthesis service system of claim 9, wherein the processor is configured to generate a plurality of voice synthesis models for the speaker and use only the selected first text among the plurality of predefined first texts for the voice synthesis.

14. The artificial intelligence-based voice synthesis service system of claim 9, wherein the processor is configured to call the generated voice synthesis model for the speaker corresponding to the speaker ID when receiving a speaker ID and third text, synthesize voice for the third text based on the called voice synthesis model and generate a synthesized voice for the third text.

15. The artificial intelligence-based voice synthesis service system of claim 14, wherein the processor is configured to receive an input for at least one of volume level, pitch, and speed for the generated synthesized voice and adjust one of a volume level, pitch, and speed for the generated synthesized voice based on the received input.
